(19) United States
(12) Patent Application Publication
(10) Pub. No.: US 2011/0154004 A1
(43) Pub. Date: Jun. 23, 2011

(54) Installing and Configuring Software and/or Hardware Components Using Metadata Representations of Component Interdependencies

(75) Inventor: Jeffrey M. Fischer, Sunnyvale, CA (US)

(73) Assignee: genForma Corp, Sunnyvale, CA (US)

(21) Appl. No.: 12/978,303

(22) Filed: Dec. 23, 2010

Related U.S. Application Data
(60) Provisional application No. 61/289,947, filed on Dec. 23, 2009.

(51) Int. Cl. G06F 9/00

(52) U.S. Cl. 713/1

(57) ABSTRACT

Process embodiments, implementations of the process embodiments, and products of the processes are disclosed that may be stored as files on a memory device, or as components in a database. Operating a computer based upon a metadata representation of a component and its interdependency with at least one other component is disclosed. Apparatus embodiments include implementation software components, memory devices and/or servers containing the implementation software component and/or an installation package for the implementation software components. Components may also be hardware components, hardware-software components, or virtual hardware components.

### CROSS REFERENCE TO RELATED APPLICATIONS

This application claims the benefit of the priority of U.S. Provisional Patent Application Ser. No. 61/289,947, filed Dec. 23, 2009, entitled “Representation for Software Inter-dependencies and Method for Installing and Configuring Collections of Inter-dependent Software Components” which is incorporated herein by reference in its entirety.

### TECHNICAL FIELD

This invention relates to coordinating the installation and configuration of software and/or hardware related components using metadata representations of their interdependencies.

### BACKGROUND OF THE INVENTION

The interdependence of software and/or hardware components, while providing for re-usability, has made the job of installation and configuration of these components complicated and error-prone. This situation regularly challenges people, organizations and enterprises of all sizes. Installation or modification of these components can stall or disable commercial, manufacturing, communication and transportation systems because of their unexpected side effects.

### SUMMARY OF INVENTION

The invention includes process embodiments, implementations of the process embodiments, and products of the processes, which may be stored as files on a memory device, or as objects in a database.

As used herein, a component may include a component type, a component description and/or one or more configuration properties.

The component type may be implicit, for example, in systems that only manage one type of component, for instance, software components. In other system embodiments, the component type may indicate any of a software component, a hardware component, a hardware-software component, or a virtual hardware component.

By way of example, the component description may include any combination of a name, a version identifier, a manufacturer, a model identifier and/or a serial number.

By way of example, the configuration properties may include any combination of input port properties, output port properties, configuration symbol properties and/or configuration file properties.

The process embodiments may include any combination of one or more of the following process steps performed on at least one computer:
The first process step: Representing a component to create a metadata representation of the interdependency of that component and one or more needed components. The metadata representation may include a dependency requirement, and/or a compatibility requirement, and/or a relationship description, and/or a configuration dependency. (Note that the metadata representations of many components may include most or all of these elements.)
   The dependency requirement may include one or more dependency constraints, possibly arranged in one or more lists whose satisfaction can be used to determine which of the needed components may need to be installed or modified to install the component.
   The compatibility requirement may include at least one constraint on a version identifier of the component.
   The relationship description may be indicated by one of the following relationship terms: environment, peer, or inside.
      As used herein, a component A has an environment dependency on component B if it depends on component B being installed in an enclosing resource. As an example, the software component Tomcat has an environment dependency on Java. It is not installed inside of Java, but requires that Java be installed on the computer configured to operate the Tomcat component.
      As used herein, a component A has a peer dependency on component B, if it calls B through some kind of interprocess communication mechanism such as Web Services or the TCP/IP communications protocol. For example, the software component OpenMRS has a peer dependency on the software component MySQL.
      As used herein, a component A has an inside dependency on component B if it must be installed/operated inside of component B. For example, the software component OpenMRS depends upon being inside the component Tomcat, and Tomcat depends upon being inside a particular Operating System.
   The configuration dependency may involve any combination of the following:
      Mapping of ports for a network node such as a web site, a financial transaction processor, a database engine, a disk farm, RAID and/or a server farm between the component and the needed component.
      Asserting or unasserting one or more configuration symbols in an operating environment, such as an operating system.
      Creating and/or altering configuration files in the operating environment.
      Extending or otherwise altering a configuration search path to find one or more configuration files.

The second process step: Using the metadata representation of at least one component requested for installation.
If the interdependency requirements can be satisfied, this process step creates an installation set of components, a specification of configuration variables for each of the components of the installation set, and an execution ordering for the installation, the configuration and the startup operation for each of the components of the installation set.
Should the requested software component be infeasible due to dependency conflicts, this process step may create a statement of infeasibility and/or a listing of the conflicting dependency requirements.
The request for the component may be received by the computer operating this process step as part of a message that may further specify a level of detail for output of this process step. By way of example, enterprise management may only be concerned with whether or not it is feasible to install a software or hardware component, which is the output of this process step with minimal details.
The installation set of components satisfies all the dependency requirements of the requested component for installation and may include one or more component instances that may have specific configuration properties that satisfy all the relevant dependency requirements.
The specification of configuration variables for each of the components of the installation set is based on the configuration dependencies of the requested component and the components of the installation set.
The execution ordering for the installation, the configuration and/or the startup operation for each of the components of the installation set, may include configuring one of the components to properly connect with another. Note, that it may be the case that two or more components may each need to be configured to connect with one another.

The third process step: Managing components of a web site based upon the dependency representations of the installed components of the web site to support patching, upgrading, and/or uninstalling components.
As used herein, a patch typically does not involve any configuration changes, additions of components, or removal of components. A patch only involves updates to existing installed components.
As used herein, an uninstall involves only the removal of one or more components, and possibly configuration changes to remaining components.
As used herein, an upgrade may involve adding new components, uninstalling one or more components, and/or patching one or more possibly different components, as well as possibly altering the configuration of one or more installed components.
When completed, the process steps that support patching, uninstalling, and/or upgrading produce the following: a new set of components, a categorization of the components, and the execution ordering of the operation.

The fourth process step: Managing enterprise architectures based upon a library of metadata representations of installed components.

The categorization of the components may be indicated by the terms of unchanged, modified, new and to-be-removed.

The execution ordering may include any combination of the following:
Stopping existing components to create a stopped component.
Uninstalling the stopped component that is to be removed.
Installation and configuration of a new component.
Upgrades of a stopped component.
Changing the configuration of the stopped component to create a new configuration.
Restarting the stopped component in the new configuration.

Implementations of the process embodiments include various apparatus configured to implement at least one of the above process steps and may include any combination of the following:
At least one implementation software component of at least part of one of the above steps or their refinements.
A memory device containing the implementation software component.
A server containing an installation package of the implementation software component and configured to deliver the installation package to at least one computer.
The computer configured by the implementation software component to create at least one program component configured to instruct the computer to implement the process step.

### BRIEF DESCRIPTION OF THE DRAWINGS

FIG. 1 shows a block diagram of an example system that may implement at least some of the disclosed processes and is based upon at least one component that may include a component type, a component description and/or one or more configuration properties. A computer is configured, and in this example, includes a means for operating the computer based upon a metadata representation of the component and its interdependency with a needed component.

FIG. 2A to 2C show some examples of the components of FIG. 1.

FIGS. 2D to 2F show some examples of the requested components, the metadata representations, and the needed components of FIG. 1.

FIG. 3 shows a block diagram of an example implementation of FIG. 1, where the means for operating may interact with a graphical user interface and/or a text based interface at the direction of one or more users. The means for operating may communicate with any combination of at least one instance of the means for representing the metadata representations, the means for using, the means for managing the web site, and/or the means for managing the enterprise architecture.

FIG. 4 shows a block diagram of a memory device and/or a server that may contain an implementation software component.

FIG. 5 shows some details of the representing to create the metadata representation.

FIG. 6 shows some details of the dependency requirement included in the metadata representation first shown in FIG. 1.

FIG. 7 shows some details of the configuration dependency of FIG. 6.

FIG. 8 shows some details of the Port binding of FIG. 7.

FIGS. 9A to 9D show some details of the relationship description of the component with the needed component of FIG. 1.

FIG. 10 shows some details of the step and/or means for using the metadata representation of at least one component requested for installation.

FIG. 11 shows some details of the steps or means to determine feasibility of installing the component of FIG. 10.

FIG. 12 shows the feasibly-responding of FIG. 10 creating an installation set, a specification of the configuration of the components of the installation set and an execution ordering of the components of the installation set.

FIG. 13 shows the in-feasibility-responding of FIG. 10 creating a statement of infeasibility and/or a listing of conflicting dependency requirements.

FIG. 14 some details of managing said installed components of said web site based upon said metadata representations.

FIG. 15 shows managing the web site may also create a new set of components, a categorization of the components of the new set and an execution ordering of the components of the new set.

FIG. 16 shows some details of categorization of one of the components 20 of the new set.

FIG. 17 shows some details of the execution ordering of FIG. 11 and/or the execution ordering of FIG. 14.

FIGS. 18A to 18C show some examples of operating the computer based upon the metadata representations that may include various embodiments that graphically-operate and/or textually-operate the computer.

### DETAILED DESCRIPTION OF DRAWINGS

This invention relates to coordinating the installation and configuration of software and/or hardware related components using metadata representations of their interdependencies. The invention includes process embodiments, implementations of the process embodiments, and products of the processes, which may be stored as files on a memory device, or as components in a database. The process embodiments may be implemented as process steps performed on at least one computer.

While it is more common in software engineering to primarily discuss processes, the hardware embodiments will be discussed first to clarify the elements of the invention in terms of systems that may implement the disclosed processes.

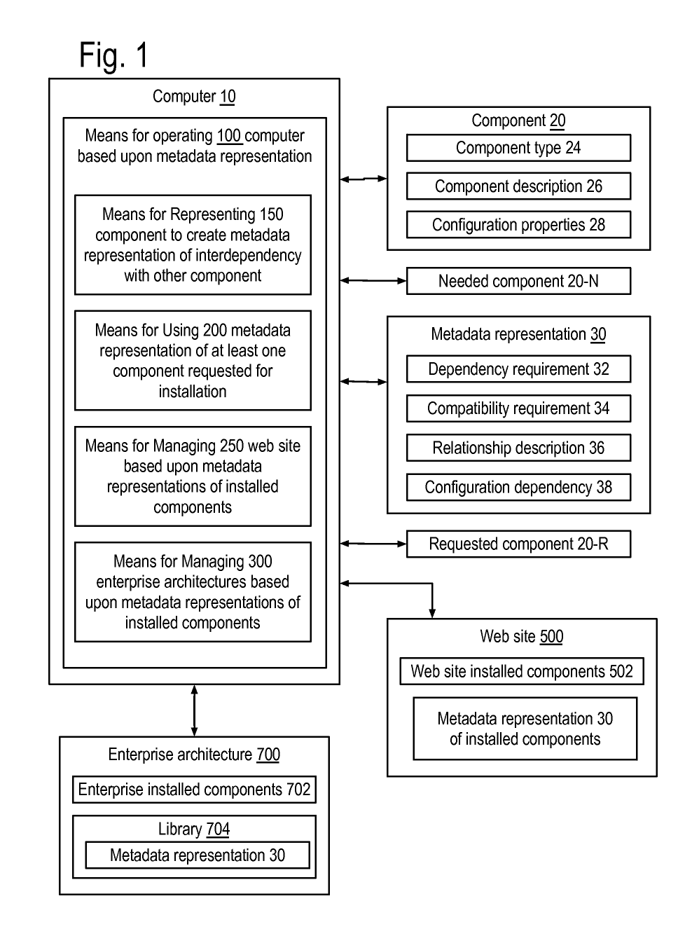

FIG. 1 shows a block diagram of an example system that may implement at least some of the disclosed processes and is based upon at least one component 20 that may include a component type 24, a component description 26 and/or one or more configuration properties 28. A computer 10 is configured, and in this example, includes a means for operating 100 the computer 10 based upon a metadata representation 30 of a component 20 and its interdependency with a needed component 20-N.

The metadata representation 30 may include at least one instance of any of the following: a dependency requirement 32, a compatibility requirement 34, a relationship description 36, and/or a configuration dependency 38. In some situations, the metadata representation 30 may include exactly one of these components 32, 34, 36, or 38. In some situations the metadata representation 30 may include at least two of the components. In certain further situations, the metadata representation 30 may include three or more of the components. And in some common situations, the metadata representation 30 may include instances of each of these components.

In this example, the means for operating 100 the computer 10 may include at least one and possibly any combination of the following:
Means for representing 150 the component 20 to create the metadata representation 30 of its interdependency with the needed component 20-N.
Means for using 200 said metadata representation 30 of at least one of said component 20 requested for installation.
Means for managing 250 installed components 502 of a web site 500 based upon said metadata representations 30 of said installed components 502. The means for managing 250 may further support at least one of patching, upgrading and/or uninstalling of at least one of said installed components 502.
Means for managing 300 an enterprise architecture 700 based upon a library 74 of said metadata representations 30 of said installed components 702 in said enterprise architecture 700.
Each of the means 100, 150, 200, 250, and 300 implement an operational step that the computer 10 has been configured to perform in various embodiments of the invention.

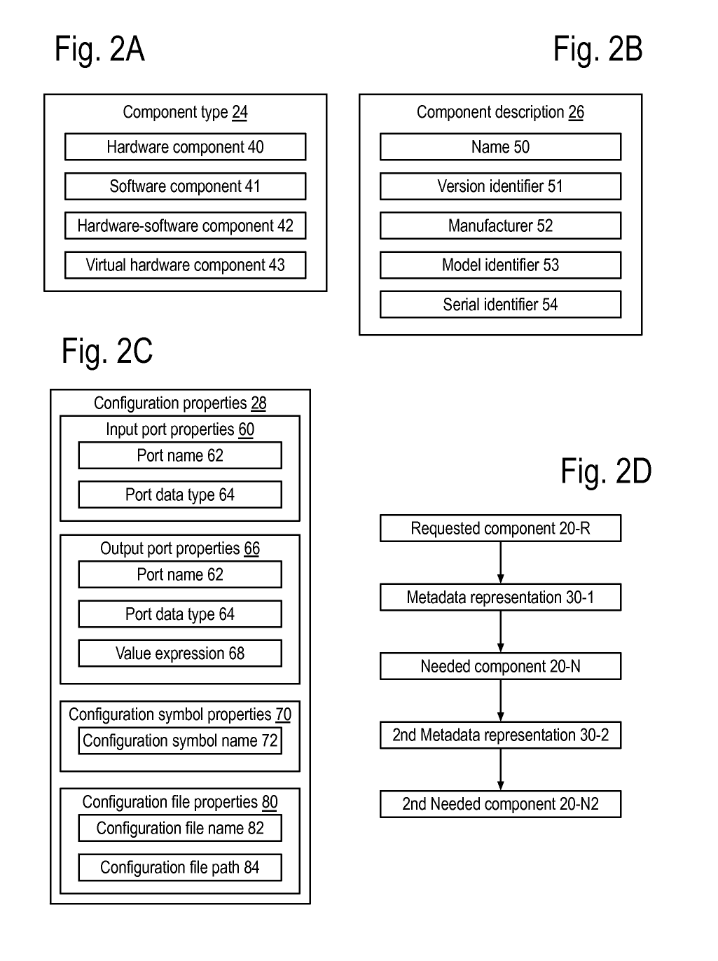

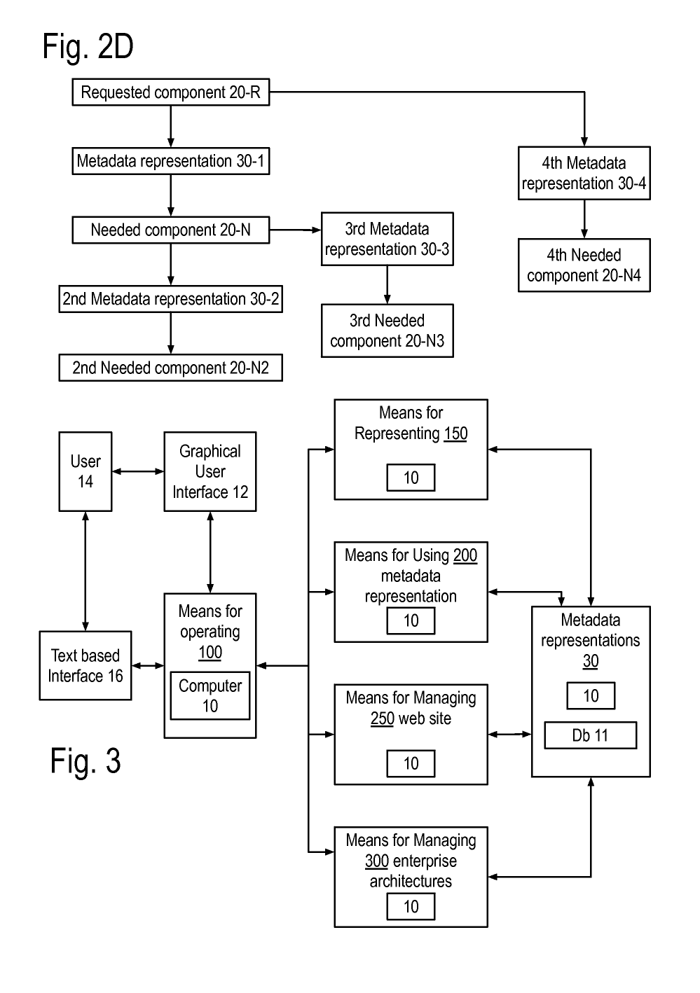

FIG. 2A to 2C show some examples of the components of FIG. 1. The component 20 and/or the needed component 20-N may be the same or different component type 24, possibly as shown in FIG. 2A. The component type may be implicit, for example, in systems that only manage one type of component, for instance, software components. In other system embodiments, the component type 24 may indicate any of several types as shown in FIG. 2A.

FIG. 2A shows some examples of the component type 24 as indicating a hardware component 40, a software component 41, a hardware-software component 42, and a virtual hardware component 43.
A hardware component 40 may indicate one or more of the following: a computer, a handheld device, a sensor node, a camera, an instrument, a Local Area Network (LAN) router, a server, a Wireless (LAN) router, a network node, a disk drive, a Redundant Array of Inexpensive Disks (RAID), and/or a disk farm.
A software component 41 may indicate at least one of an operating system such as Unix, Linux, and/or a windowing operating system, an operating environment such as a Java runtime environment, a software component such as Tomcat, OpenMRS, MySQL, a protocol handler such as a TCP-IP stack processor, and/or an instrumentation interface software.
A hardware-software component 42 may indicate at least one hardware component operating at least one software component as a unit. By way of example, a hardware-software component 42 may indicate that an instrument interacts with a computer running an instrumentation interface software and a protocol handler assigned to communicate via a network node of a LAN.
A virtual hardware component 43 may indicate a virtual machine and/or a system virtual machine, both of which execute programs like a physical machine. In either case, the software running inside is limited to the resources and abstractions provided by the virtual machine and cannot break out of its virtual world. The virtual machine may just run one process, whereas the system virtual machine may run an operating system and possibly support multi-tasking where several processes can be performed concurrently.
Another example of a virtual hardware component 43 may indicate a virtual instrument including both customizable software components and modular measurement hardware components. These components may be used to create a virtual oscilloscope and/or a frequency response estimator based upon hardware components of an Analog to Digital Converter (ADC) and possibly a Digital to Analog Converter (DAC) both coupled to a test stand. The DAC may be used to stimulate the test stand and the ADC to measure a response to the stimulus. A Fast Fourier Transform (FFT) software component may execute on a computer receiving the ADC outputs to drive an oscilloscope front end software component driving a graphical user interface 12 as shown in FIG. 3 as used to operate 100 the computer 10 based upon the metadata representations 30.

FIG. 2B shows some examples of the component description 26 may include any combination of a name 50, a version identifier 51, a manufacturer 52, a model identifier 53 and/or a serial number 54.

FIG. 2C shows some examples of the configuration properties 28 that may include any combination of input port properties 60, output port properties 66, configuration symbol properties 70 and/or configuration file properties 80.
Any specific component 20 may or may not have input ports, or output ports, or configuration symbol properties or configuration file properties.
The input port properties 60 may include a port name 62 and a port data type 64.
The output port properties 66 may include the port name 62 and the port data type 64 as well as a value expression 68.
The configuration symbol properties 70 may include a configuration symbol name 72.
The configuration file properties 80 may include a configuration file name 82 and possibly a configuration file path 84 that may be used to alter a path list in an operating environment, such as an operating system.

FIGS. 2D to 2F show some examples of the requested components, the metadata representations, and the needed components of FIG. 1.

FIG. 2D shows the requested component 20-R of FIG. 1 with a dependency relationship denoted by the metadata representation 30-1 with the needed component 20-N, and the needed component 20-N has a dependency denoted by metadata representation 30-2 with a second needed component 20-N2.

FIG. 2E shows the requested component 20-R depending upon a more extensive collection of needed components 20-N1 to 20-N4 as a refinement of FIG. 2D.
As in FIG. 2D, the requested component 20-R of FIG. 1 with a dependency relationship denoted by the metadata representation 30-1 with the needed component 20-N, and the needed component 20-N has a dependency denoted by metadata representation 30-2 with a second needed component 20-N2.
The requested component 20R also depends, as denoted by the fourth metadata representation 30-4 on the fourth needed component 20-N4.
The needed component 20-N also depends, as denoted by the third metadata representation 30-3 on a third needed component 20-N3.

FIG. 2F shows the requested component 20-R depending upon the same collection of needed components 20-N1 to 20-N4 as in FIG. 2E, but with the metadata representations describing multiple interdependencies.
As in FIG. 2D, the requested component 20-R of FIG. 1 with a dependency relationship denoted by the metadata representation 30-1 with the needed component 20-N, and the needed component 20-N has a dependency denoted by metadata representation 30-2 with a second needed component 20-N2.
Unlike either FIG. 2D or 2E, the metadata representation 30 also indicates the requested component 20R further depends the fourth needed component 20-N4.
   Unlike either FIG. 2D or 2E, the second metadata representation 30-2 also indicates the needed component 20-N further depends on the third needed component 20-N3.

FIG. 3 shows a block diagram of an example implementation of FIG. 1, where the means for operating 100 may interact, as shown by arrows, with a graphical user interface 12 and/or a text based interface 16 at the direction, as shown by arrows, of one or more users 14. The means for operating 100 may communicate, again shown by arrows with any combination of at least one instance of the means for representing 150 the metadata representations 30, the means for using 200, the means for managing 250 the web site 500, and/or the means for managing 300 the enterprise architecture 700.

Each of the means 100, 150, 200, 250 and 300 may operate on separate computers 10. These means may communicate with each other across at least one network that may wireless and/or wireline communications protocols. Their communications may be encrypted and/or employ other secure communications protocols such as drop boxes.

In some embodiments there may be several possibly separate metadata representations 20 similar to FIG. 1. In other situations, a single repository of metadata representations 30 may be used for multiple purposes, as shown in FIG. 3. The metadata representations 30 may reside on a computer 10 and/or on a database 11.

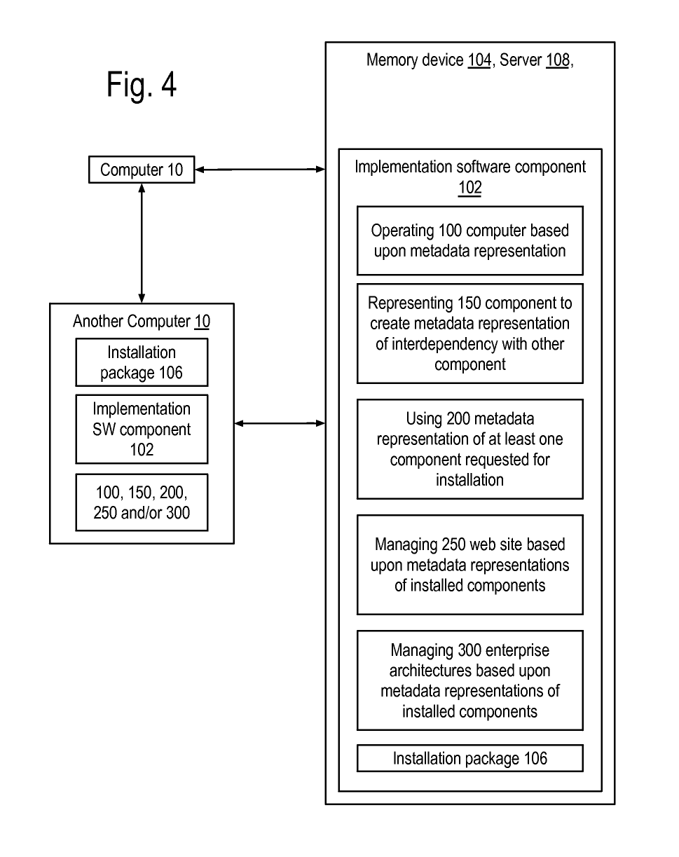

Now that the general system context has been discussed, operating the computer 10 based upon the metadata representations 30 will be discussed in terms of apparatus, in particular, a program system as an implementation software component 102 that may include program instructions for the computer 10 to at least partly implement at least one of the means 100, 150, 200, 250 and/or 300 as shown in the block diagram of FIG. 4.

FIG. 4 shows a block diagram of a memory device 104 and/or a server that may contain the implementation software component 102. The memory device 104 and/or a server 108 may contain said implementation software component 102 and/or an installation package 107 configured to instruct said computer 10 to install said implementation software component 102. The implementation software component 102 may be configured to instruct the computer 10 to at least partly implement at least one of the means for representing 150 the metadata representations 30, the means for using 200, the means for managing 250 the web site 500, and/or the means for managing 300 the enterprise architecture 700.

FIG. 4 also shows another computer 10 may be configured by the installation package 106 to install the implementation software component 102, which in turn may instruct the another computer 10 to implement at least part of the means 150, 200, 250, and/or 300 as program instructions for execution by one or both of the computers 10. These computers 10 may or may not share the same instruction set.

The computers 10 may or may not share a memory device 104. The memory device 104 may include a volatile and/or a non-volatile memory component. A non-volatile memory component will tend to retain at least one memory state without needing an external power supply. A volatile memory component will tend to lose its memory state without at least occasional recharging from an external power supply.

A computer 10 will be considered to include at least one instruction processor and at least one data processor, with each of the data processors instructed by at least one of the instruction processors. Some computers 10 may or may not have the ability to alter the instructions they can access in the memory device 104.

The memory device 104 may be implemented as a file management system that may use at least one semiconductor memory and/or at least one disk drive to store the files and possibly folders or directories of files, and so on. The memory device 104 may be implemented as a removable device, possibly implementing an interface to a Universal Serial Bus (USB) coupling and/or an Institute for Electrical and Electronic Engineering (IEEE) 1394 standard, which is sometimes known as Firewire. The memory device 104 may also be implemented to communicate via a network node, possibly acting as a shared disk drive across a network.

Having now outlined some example hardware embodiments, consider the operating 100 of the computer 10 as shown first in FIG. 1 and in further detail in FIGS. 3 and 4. Operating 100 the computer 10 may include at least one and possibly any combination of the following steps:
Representing 150 the component 20 to create the metadata representation 30 of its interdependency with the needed component 20-N.
Using 200 said metadata representation 30 of at least one of said component 20 requested for installation.
Managing 250 installed components 502 of a web site 500 based upon said metadata representations 30 of said installed components 502. The means for managing 250 may further support at least one of patching, upgrading and/or uninstalling of at least one of said installed components 502.
And/or managing 300 an enterprise architecture 700 based upon a library 74 of said metadata representations 30 of said installed components 702 in said enterprise architecture 700.

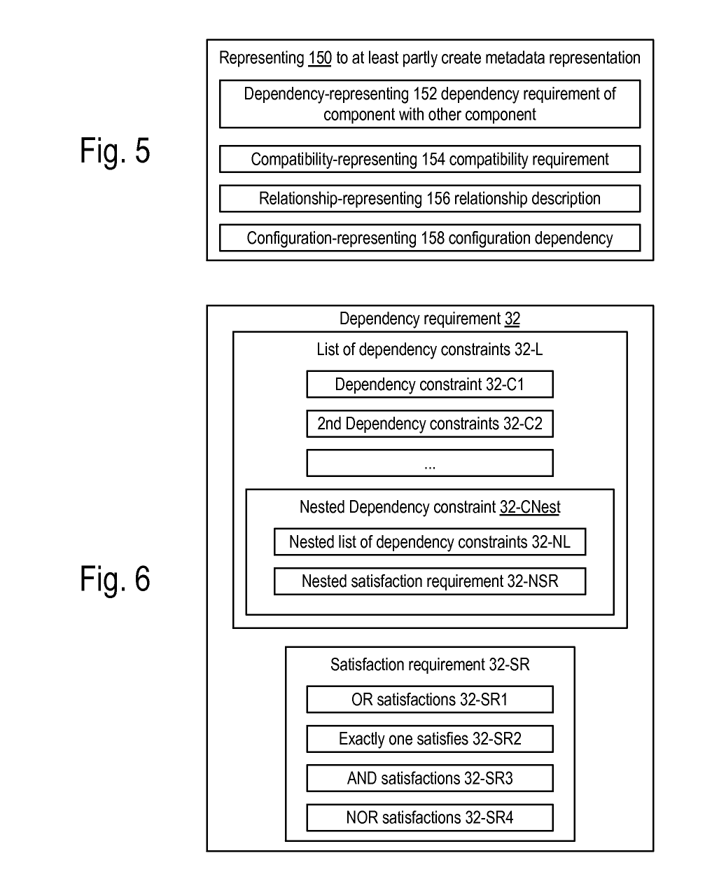

FIG. 5 shows that the representing 150 to create the metadata representation 30 may further include at least one of the following steps that may at least partly create said metadata representation 30:
Dependency-representing 152 said dependency requirement of said component with said needed component.
Compatibility-representing 154 said compatibility requirement of said component with said needed component.
Relationship-representing 156 said relationship description of said component with said needed component.
And/or configuration-representing 158 said configuration dependency of said component with said needed component.

FIG. 6 shows some details of the dependency requirement 32 included in the metadata representation 30 first shown in FIG. 1. The dependency requirements 32 may include at least one list 32-L and a satisfaction requirement 32-SR for the list 32-L.
The list 32-L may include at least two dependency constraints 32-L1, 32-L2 and so on.
By way of example, the satisfaction requirement 32-SR may indicate one of the following
   The OR-ing of satisfactions 32-SR1 refers to this dependency requirement being satisfied by at least one of the dependency constraints 32-C1, 32-C2 and so on in the list 32-L. In Boolean algebra, OR-ing several premises yields a truth if one or more of the premises is true.
   Satisfied by exactly one 32-SR2 of the dependency constraints 32-C1, 32-C2 and so on in the list 32-L. An example of this is if one of several versions of an operating system may satisfy a constraint, in most situations a computer 10 cannot run more than one operating system, so only one dependency would be satisfied.
   And-ing of satisfactions 32-SR3 refers to satisfying all of the dependency constraints 32-C1, 32-C2 and so on in the list 32-L. In Boolean algebra, AND-ing several premises yields a truth if all of the premises are true.
   NOR-ing satisfactions 32-SR4 refers to Satisfying by none of the dependency constraints 32-C1, 32-C2 and so on in the list 32-L. This satisfaction requirement 32-SR could be considered to require that all of the dependency constraints fail. In Boolean algebra, AND-ing several premises yields a truth if all of the premises are false.

Note that these examples of the satisfaction requirement 32-SR are by no means exhaustive, a first order predicate calculus of based around the Boolean operations of conjunction (AND-ing 32-SR3), disjunction (OR-ing 32-SR1) and negation (NOR-ing 32-SR4 a list of one dependency constraint) could be said to span the space of satisfaction constraints in terms of Boolean valued satisfaction of the dependency constraints.

To address this extensibility, the list of dependency constraints 32-L may include at least one nested dependency constraint 32-CNest, which may include a nested list of dependency constraints 32-NL and a nested satisfaction requirement 32- NSR. The nested list of dependency constraints 32-NL may further include another layer of nested dependency constraints similar to 32-CNest, and so on. While some may find this recursion of dependency constraints cumbersome, it is a frequently used tool in software engineering to account for the complexities of interdependency found in real systems on a daily basis.

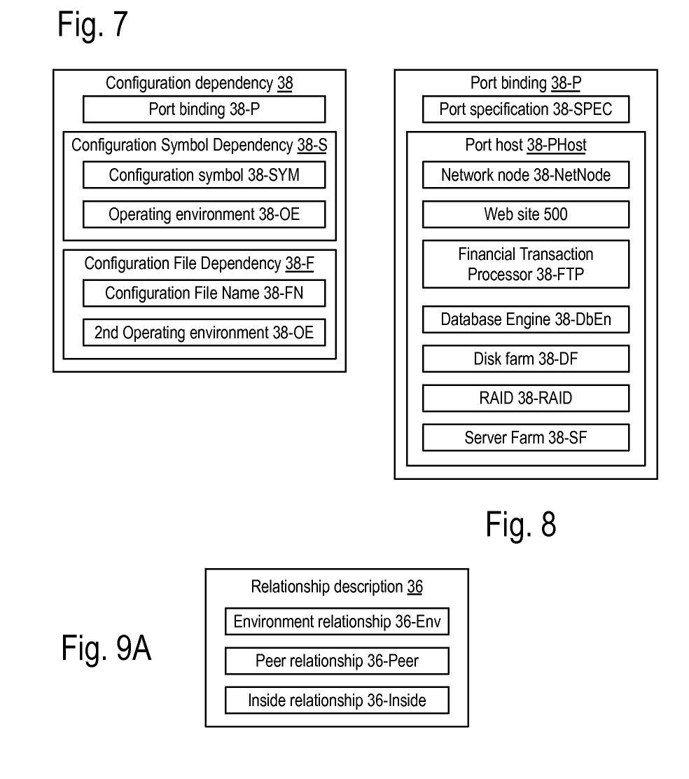

FIG. 7 shows some details of the configuration dependency 38 included in the metadata representation 30 first shown in FIG. 1. The configuration dependency 38 may include any combination of one or more of a port binding 38-P, a configuration symbol dependency 38-S and/or a configuration file dependency 38-F.
The configuration symbol dependency 38-S may include a configuration symbol 38-SYM and an operating environment indication 38-0E, which together may represent a constraint regarding the configuration symbol 38-SYM in the operating environment 38-0E.
   By way of example, a particular component 20 may require the needed component 20-N to have the configuration symbol 38-S defined for a specific operating environment 38-0E.
   Another example, the configuration symbol 38-S may be required to not be defined in the operating environment 38-0E.
The configuration file dependency 38-S may include a configuration file 38-SYM and an operating environment indication 38-0E, which together may represent a constraint regarding the configuration file 38-SYM in the operating environment 38-0E.
   By way of example, a particular component 20 may require the needed component 20-N to have the configuration file 38-S defined for a specific operating environment 38-0E.
   Another example, the configuration file 38-S may be required to not be defined in the operating environment 38-0E.

FIG. 8 shows some details of the Port binding 38-P of FIG. 7, which may include at least one port specification 38-SPEC for at least one port host 38-PHost. By way of example, the port host 38-PHost may include a network node 38-NetNode, the web site 500, a financial transaction processor 38-FTP, a database engine 38-DbEn, a disk farm 39-DF, a Redundant Array of Inexpensive Disks (RAID) 38-RAID, and/or a server farm 38-SF.

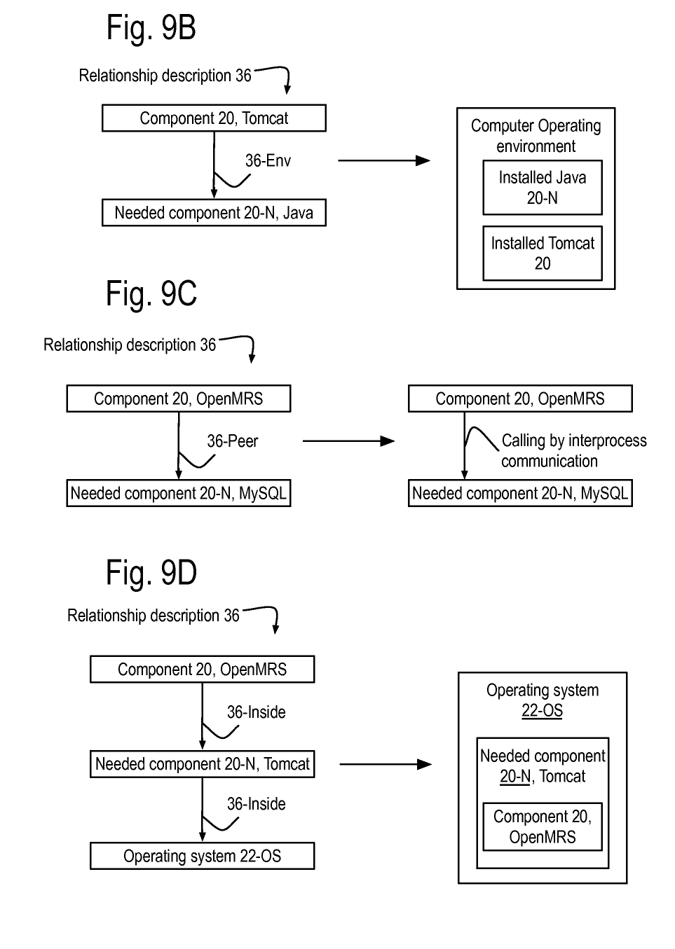

FIGS. 9A to 9D show some details of the relationship description 36 of the component 20 with the needed component 20-N.

FIG. 9A shows some details of the relationship description 36 of the component 20 with the needed component 20-N as shown in FIG. 1. The relationship description 36 may indicate one of an environment relationship 36-Env, a peer relationship 36-Peer, or an inside relationship 36-Inside.

FIG. 9B shows an example of the component 20 having an environment dependency 36-Env on the needed component 20-N, in that it depends on the needed component 20-N being installed in an enclosing resource. As an example, the Tomcat software component 22 has an environment dependency on Java as the needed component 20-N. It is not installed inside of Java, but requires that Java be installed on the computer configured to operate the Tomcat component.

FIG. 9C shows an example of the component 20 having a peer dependency 36-Peer on the needed component 20-N, if it calls the needed component 20-N through some kind of interprocess communication mechanism such as Web Services or the TCP/IP communications protocol. For example, the OpenMRS software component 20 has a peer dependency on the MySQL other software component 22.

FIG. 9D shows an example of the component 20 having an inside dependency 36-Inside on the needed component 20-N if it must be installed/operated inside of the needed component 20-N. For example, the OpenMRS software component 20 depends upon being inside the Tomcat other software component 22, and Tomcat depends upon being inside 36-Inside a particular Operating System 22-OS.

The request for the component 20 may be received by the computer 10 operating this process step, possibly as shown in FIG. 3 as part of a message that may further specify a level of detail for output of this process step. For example, enterprise management 300 may only be concerned with whether or not it is feasible to install a software component 41 and/or a hardware component 40, which is the output of this process step with minimal details.

FIG. 10 shows some details of the step and/or means for using 200 the metadata representation 30 of at least one component 20 requested for installation by including the following:
Feasibility-determine 202 to create a feasibility-determination based upon installing said requested component 20-R,
Feasibly-respond 204 to said feasibility-determination being feasible, and
In-feasibility-respond 206 to said feasibility-determination being feasible.

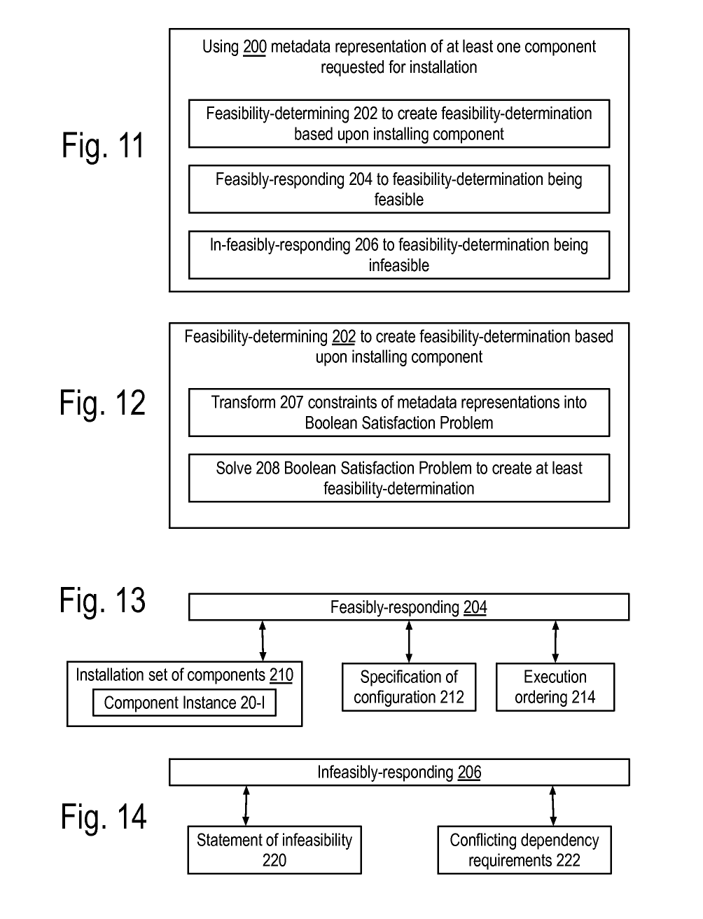

FIG. 11 shows some details of the steps and/or means to determine feasibility 202 of installing the requested component 20-R of FIG. 10, by including the following:
Transforming 207 the constraints of the metadata representations 30 into a Boolean Satisfaction Problem, and
Solving 208 the Boolean Satisfaction Problem to create at least the feasibility determination.

FIG. 12 shows the step and/or means for feasibly-responding 204 of FIG. 10 creating an installation set 210 of at least one component instance 20-I, a specification 212 of the configuration of the components of the installation set 210 and an execution ordering 214 of the components of the installation set 210.
The component instance 20-I is a component 20 whose configuration properties 26 satisfy the relevant dependency requirements 32, either as the installed instance of the requested component 20-R and/or as an installed instance of one of the needed components 20-N.
The specification of configuration variables 212 for each of the component instances 20-i of the installation set 210 may be based on the configuration dependencies 38 of the requested component 20-R and the other component instances 20-I of the installation set 210.
The execution ordering 214 for the installation, the configuration and/or the startup operation for each of the component instances 20-I of the installation set 210, may include configuring one of the components to properly connect with another. Note, that it may be the case that two or more components may each need to be configured to connect with one another.

FIG. 13 shows the step and/or means for in-feasibility-responding 206 of FIG. 10 creating a statement of infeasibility 220 and/or a listing of conflicting dependency requirements 222.

FIG. 14 shows some details of managing 250 said installed components 502 of said web site 500 based upon said metadata representations 30 as further including at least one of
Managing patching 252 of at least one of said installed components 502. A patch typically does not involve any configuration changes, additions of components, or removal of components. A patch only involves updates to existing installed components 502.
Managing upgrading 254 of at least one of said installed components 502. As used herein, an upgrade may involve adding new components, uninstalling one or more components, and/or patching one or more possibly different components.
Managing uninstalling 256 at least one of said installed components 502. An uninstall involves only the removal of one or more components, and possibly configuration changes to remaining installed components 502.

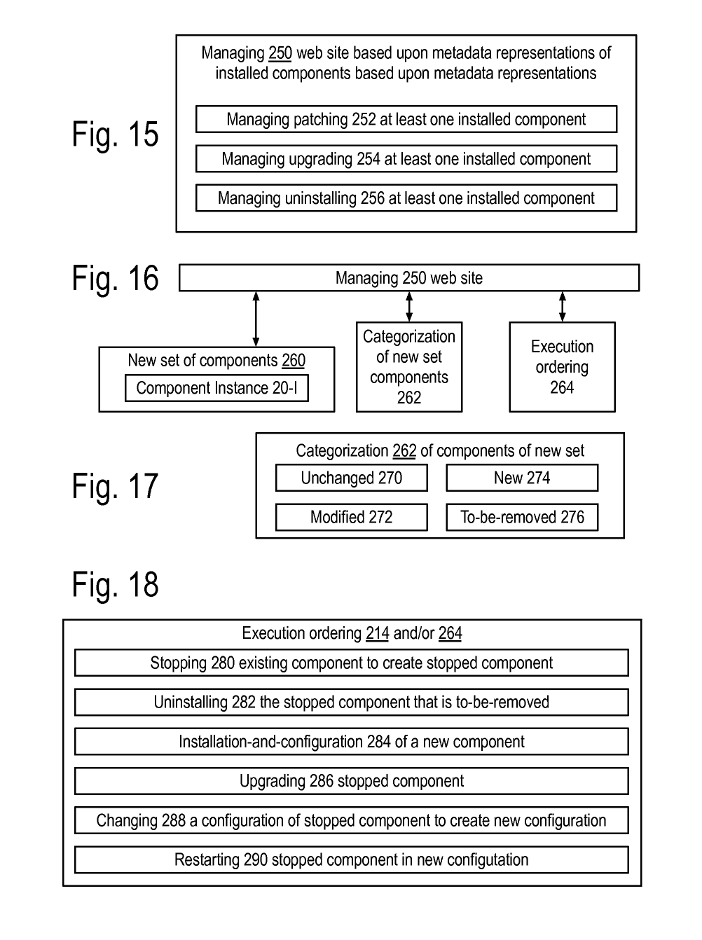

FIG. 15 shows managing 250 the web site 500 may also create a new set 260 of component instances 20-I, a categorization 262 of the component instances 20-I of the new set 260 and an execution ordering 264 of the component instances 20-I of the new set 260.

FIG. 16 shows some details of categorization 262 of one of the components 20 of the new set 260, which may indicate one of the following: the component 20 is unchanged 270, the component 20 is modified 272, the component 20 is new 274, or the component 20 is to-be-removed 276.

FIG. 17 shows some details of the execution ordering 214 of FIG. 11 and/or the execution ordering 264 of FIG. 14 that may include at least one of the following
Stopping 270 an existing component 20 to create a stopped component.
Uninstalling 272 the stopped component that is to-be-removed 276.
Installation-and-configuration 274 of a new component.
Upgrading 276 the stopped component.
Changing 278 a configuration of the stopped component to create a new configuration.
And/or restarting the stopped component in the new configuration.

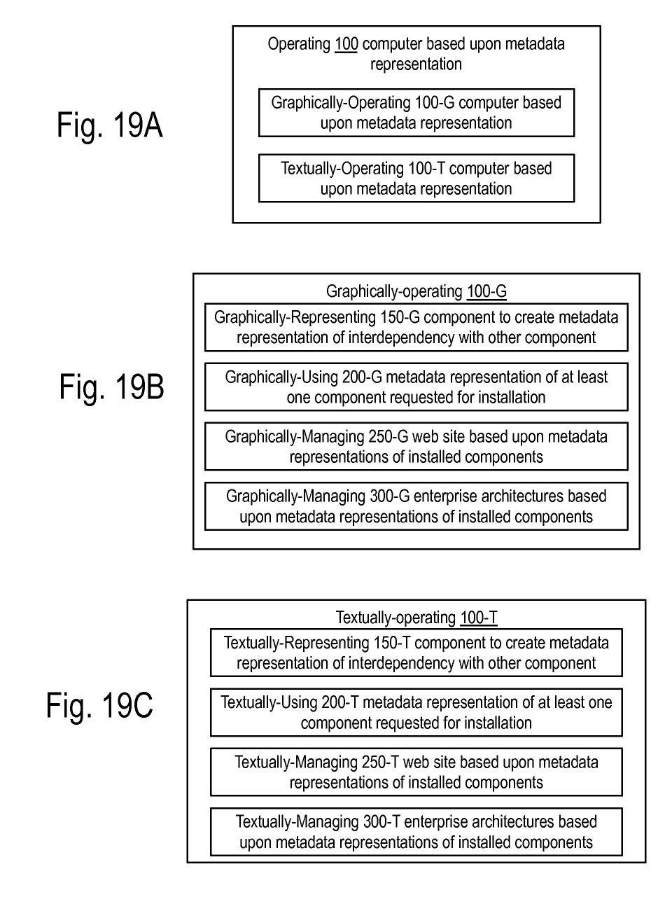

From FIG. 3, it can be seen that the user 14 may operating 100 the computer(s) 10 through various interfaces that may include a graphical user interface 12 and/or a text based interface 16. FIGS. 18A to 18C show some examples of operating 100 the computer 10 based upon the metadata representations 30 that may include various embodiments that graphically-operate 100-G and/or textually-operate 100-T the computer 10.

FIG. 18A shows the step of operating 100 the computer(s) 10 based upon the metadata representation(s) 30 may include any combination of graphically-operating 100-G and/or textually-operating 100-T the computer(s) 10 based upon the metadata representation(s) 30.

FIG. 18B shows a detail of graphically-operating 100-G that may include any combination of one or more of the following steps and their corresponding means in hardware implementations:
Graphically-representing 150-G the component 20 to create the metadata representation 30 of its interdependency with the needed component 20-N.
Graphically-using 200-G said metadata representation 30 of at least one of said component 20 requested for installation.
Graphically-managing 250-G installed components 502 of a web site 500 based upon said metadata representations 30 of said installed components 502. The means for managing 250 may further support at least one of patching, upgrading and/or uninstalling of at least one of said installed components 502.
And/or graphically-managing 300-G an enterprise architecture 700 based upon a library 74 of said metadata representations 30 of said installed components 702 in said enterprise architecture 700.

FIG. 18C shows a detail of textually-operating 100-T that may include any combination of one or more of the following steps and their corresponding means in hardware implementations:
Textually-representing 150-T the component 20 to create the metadata representation 30 of its interdependency with the needed component 20-N.
Textually-using 200-T said metadata representation 30 of at least one of said component 20 requested for installation.
Textually-managing 250-T installed components 502 of a web site 500 based upon said metadata representations 30 of said installed components 502. The means for managing 250 may further support at least one of patching, upgrading and/or uninstalling of at least one of said installed components 502.
And/or textually-managing 300-T an enterprise architecture 700 based upon a library 74 of said metadata representations 30 of said installed components 702 in said enterprise architecture 700.

The preceding discussion serves to provide examples of the embodiments and is not meant to constrain the scope of the following claims.

1. A method, comprising the step of:
operating at least one computer based upon a metadata representation of a component and its interdependency with at least one other component,
with said metadata representation including at least one of a dependency requirement, a compatibility requirement, a relationship description, and/or a configuration dependency.

2. The method of claim 1, wherein said component is a member of a component type group consisting of a hardware component, a software component, a hardware-software component, and a virtual hardware component.

3. The method of claim 2, wherein said needed component is another of said members of said component group.

4. The method of claim 1, wherein said metadata representation includes at least two of said dependency requirement, said compatibility requirement, said relationship description, and/or said configuration dependency.

5. The method of claim 1, wherein said metadata representation includes at least three of said dependency requirement, said compatibility requirement, said relationship description, and/or said configuration dependency.

6. The method of claim 1, wherein said metadata representation includes each of said dependency requirement, said compatibility requirement, said relationship description, and said configuration dependency.

7. The method of claim 1, wherein the step operating said computer further comprises at least one of the steps of:
representing said component to create said metadata representation of said component and said its interdependency with said needed component;
using said metadata representation of at least one of said component requested for installation;
managing installed components of a web site based upon said metadata representations of said installed components; and
managing an enterprise architecture based upon a library of said metadata representations of said installed components in said enterprise architecture.

8. The method of claim 7, wherein the step of representing said component to create said metadata representation of said component and said its interdependency with said needed component, further comprises at least one of the steps of:
dependency-representing said dependency requirement of said component with said needed component to at least partly create said metadata representation;
compatibility-representing said compatibility requirement of said component with said needed component to at least partly create said metadata representation;
relationship-representing said relationship description of said component with said needed component to at least partly create said metadata representation; and
configuration-representing said configuration dependency of said component with said needed component to at least partly create said metadata representation.

9. The method of claim 8, wherein said dependency requirement may include a list of dependency constraints and a satisfaction requirement for said list; and
wherein said configuration dependency includes at least one of a port binding, an configuration symbol dependency, and a configuration file dependency,
with said port binding constraining at least one port specification for at least one port host,
with said port host including at least one of a network node, said web site, a financial transaction processor, a database engine, a disk farm, a RAID, and/or a server farm,
with said configuration symbol dependency constraining a configuration symbol in an operating environment, and
with said configuration file dependency constraining a configuration file in said operating environment; and
wherein said relationship description may indicate a member of a relationship-type group consisting of an environment relationship, a peer relationship, and an inside relationship.

10. The method of claim 9, wherein said satisfaction requirement indicates one of
satisfied by at least one of said dependency constraints of said list,
satisfied by exactly one of said dependency constraints of said list,
satisfied by all of said dependency constraints of said list, and
satisfied by none of said dependency constraints of said list.

11. The method of claim 7, wherein the step of using said metadata representation of at least one of said component requested for installation, further comprises the steps of
feasibility-determining to create a feasibility-determination based upon installing said component;
feasibly-responding to said feasibility-determination being feasible; and
in-feasibility-responding to said feasibility-determination being feasible.

12. The method of claim 11, wherein the step feasibly-responding to said feasibility-determination being feasible creates
an installation set of components,
a specification of configuration variables for each of said components of said installation set, and
an execution ordering for installation, configuration and startup operation for each of said components of said installation set; and
wherein the step in-feasibility-responding to said feasibility-determination being feasible creates a statement of infeasibility and/or a listing of conflicting dependency requirements.

13. The method of claim 11, wherein the step of feasibility-determining further comprises the steps of:
transforming said metadata representations into a Boolean Satisfaction Problem; and
solving said Boolean Satisfaction Problem to create at least said feasibility-determination.

14. The method of claim 7, wherein the step of managing said installed components of said web site based upon said metadata representations of said installed components, further comprises at least one of the steps of:
managing patching of said at least one installed components of said web site based upon said metadata representations;
managing upgrading of said at least one installed components of said web site based upon said metadata representations; and
managing uninstalling of said at least one installed components of said web site based upon said metadata representations.

15. The method of claim 14, wherein the step of managing said installed components of said web site further creates a new set of said components, a categorization of said components belonging to said new set, and an execution ordering of the operation of said components belonging to said new set.

16. The method of claim 15, wherein said categorization of said component indicated one of unchanged, modified, new and to-be-removed.

17. The method of claim 15, wherein said execution ordering includes at least one of the steps of:
stopping an existing component to create a stopped component;
uninstalling the stopped component that is to be removed;
installation-and-configuration of a new component;
upgrading of said stopped component;
changing a configuration of said stopped component to create a new configuration; and
restarting said stopped component in said new configuration.

18. The method of claim 7,
wherein the step operating said computer based upon said metadata representation of said component and its interdependency with said at least one other component, further comprises at least one of the steps of:
graphically-operating said computer based upon said metadata representation of said component and its interdependency with said at least one other component, and/or
textually-operating said computer based upon said metadata representation of said component and its interdependency with said at least one other component.

19. An apparatus configured to implement at least part of the method of claim 7, comprising at least one of
means for operating said at least one computer based upon said metadata representation of said component and said interdependency with said needed component;
means for representing said component to create said metadata representation of said component and said interdependency with said needed component;
means for using said metadata representation of at least one of said component requested for said installation;
means for managing said installed components of said web site based upon said metadata representations of said installed components; and
means for managing said enterprise architecture based upon said library of said metadata representations of said installed components in said enterprise architecture.

20. The apparatus of claim 19, wherein at least one member of a means group includes at least one of
at least one implementation software component of at least part of one of said member;
a memory device containing said implementation software component and/or an installation package configured to instruct said computer to install said implementation software component;
a server containing said installation package and/or said implementation software component configured to be delivered to another of said computer; and
said another of said computer configured by said implementation software component to create at least one program component configured to instruct said another computer to implement said member of said means group;
wherein said means group consists of the members of said means for operating, said means for representing, said means for using, said means for managing said installed components of said web site, and said means for managing said enterprise architecture.
